(19) United States
(12) Patent Application Publication
(10) Pub. No.: US 2010/0205329 A1
(43) Pub. Date: Aug. 12, 2010

(54) FILE INPUT/OUTPUT METHOD

(75) Inventors: Toshiyuki UKAI, Machida (JP); Tsuyoshi TANAKA, Kokubunji (JP); Takashi YASUI, Fuchu (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/538,546

(22) Filed: Aug. 10, 2009

(30) Foreign Application Priority Data
Feb. 12, 2009 (JP) JP2009-29300

(51) Int. Cl. G06F 13/00; G06F 12/00

(52) U.S. Cl. 710/33; 707/E17.01; 707/E17.032

(57) ABSTRACT

Provided is a computer system comprising a computer and a plurality of storage devices. The plurality of storage devices store divided data which is obtained by dividing data contained in a file which can be accesed by the computer. The computer holds configuration information of the processor included in the computer and configuration information of the file which is stored by dividing the file; divides an I/O request of the file into a plurality of I/O requests for the plurality of storage devices; determines whether a predetermined condition is satisfied or not; and assigns a plurality of I/O threads of a number determined based on a result of the determination to the divided plurality of I/O requests. The processor inputs/outputs the divided data of the file held in the plurality of storage devices by using the assigned the plurality of I/O threads.

### CLAIM OF PRIORITY

The present application claims priority from Japanese patent application JP 2009-29300 filed on Feb. 12, 2009, the content of which is hereby incorporated by reference into this application.

### BACKGROUND OF THE INVENTION

The present invention relates to a method and a system for controlling input and output (I/O) data to and from disks equipped in a storage system, and in particular, to a file system which realizes a method for controlling input and output adapting to the connected disk device configuration in a server which connects a plurality of disk devices.

I/O throughput performance of a disk device is slow as compared to file I/O processing of software executed by the processors of a host computer. It is the same not only for one disk device but also for a disk array device.

A disk array device is also called RAID (Redundant Arrays of Inexpensive Disks), and is a storage system which has a plurality of disk devices arranged in an array and a control unit for controlling them. In the disk array device, a I/O request from a computer is processed at high speed by operating the disk device in parallel.

On the other hand, Reference 1 (JP 7-248949 A) discloses an art for improving total I/O throughput performance using a plurality of disk units (LU) (in the following, unless otherwise stated, physical disk devices and logical disk units are not distinguished). According to the art disclosed in Reference 1, the disk units are accessed in parallel by storing different files into the each of the LUs, and inputting and outputting each file by multi-process/multi-thread.

Moreover, there is also an art which can improve a performance of inputting and outputting files by striping a file from and to a plurality of LUs. Reference 2 (JP 2004-265110 A) discloses an art related to LVM (Logical Volume Manager) which makes it possible to treat a plurality of LUs as a disk unit (logical volume) logically. In accordance with the art disclosed in Reference 2, the file which should be stored is divided and the divided file is stored in a plurality of LUs by storing a file into logical volumes without UAP (User Application Program) being conscious about the divided files. In response to the file I/O request for this logical volume, the I/Os are controlled in consideration of the number of LUs.

Furthermore, Reference 3 (JP 2002-182953 A) discloses an art for a parallel file system which improves total I/O performance by using a plurality of host computers as an I/O server. In accordance with the art disclosed in Reference 3, data is exchanged between a parallel file system client executed in a server (host computer) and a parallel file system server executed in a plurality of I/O servers, through communication threads operated at each of them. Moreover, a plurality of I/O servers are operated in parallel.

### SUMMARY OF THE INVENTION

In a case where an UAP which is not a parallel program is involved, even if a plurality of LUs are integrated at one host computer using LVM, scalable performance according to the number of LUs cannot be obtained. This is because if the number of processes of UAPs which issue the I/O request is one (one thread), the context for the UAP process is executed until the I/O issue processing depending on the structure of OS (operating system). Thereby, if there is only one UAP context, I/O processing is executed only by one processor.

References 1-3 disclose I/O control that aims to improve I/O throughput performance in accordance with the number of LUs to some extent of the number of LUs, when a plurality of LUs are connected to a host computer. However, the processor (CPU) which executes I/O processing of software acts as a bottleneck, and therefore, it is not possible to improve the I/O throughput performance more.

For example, this bottleneck in the processor can be described as follows considering the memory copy processing accompanying with the I/O processing. In a case where the operating clock of a processor is 5 GHz and 8 Bytes of loading or storing is possible in one clock assuming an ideal situation, even if simple loading/storing are repeated, loading or storing of 20 GBytes/second (5 GHz×8 Bytes/2) becomes the upper limit performance. In practice, since other processing is also executed, data processing performance which can be expected with a job of one thread becomes about 20 GBytes/second divided by some numbers.

On the other hand, since a plurality of communication threads perform the communications between a calculation server and an I/O server, it is possible to perform the communications part in parallel by using a plurality of processors.

However, in the case where one UAP is involved, one processor is used in the I/O processing of the calculation server, as in the case of LVMs. Moreover, this communication thread is used only as a communications channel between the calculation server and the I/O server, and does not take into account the file structure (number of the striping), and therefore, it is difficult to perform optimization in accordance with the number of connected disk devices.

Furthermore, NUMA (Non-Uniform Memory Access) configuration is now in the main stream with regards to highly multiplexed multiprocessor servers. As disclosed in Reference 4 (US 2008/0022286 A), NUMA is an architecture whose accessing cost to the main memory and the I/O device which are shared by the plurality of processor is not uniform depending on the memory area and the processor. If we assume that the above communication thread is made to perform multiple I/O processing as the I/O thread, the location relationship between the processor to which the thread operates, and the I/O device and the memory is not restrained. In this case, when a low throughput route in a host computer is used, I/O performance degrades.

A representative aspect of this invention is as follows. That is, there is provided a computer system comprising a computer and a plurality of storage devices coupled to the computer via a network. The plurality of storage devices store divided data which is obtained by dividing data contained in a file which can be accesed by the computer. The computer comprises an interface coupled to the network, a processor coupled to the interface, and a memory coupled to the processor. The computer holds configuration information of the processor included in the computer and configuration information of the file which is stored by dividing the file; divides an I/O request of the file into a plurality of I/O requests for the plurality of storage devices; determines whether a predetermined condition is satisfied or not; and assigns a plurality of I/O threads of a number determined based on a result of the determination to the divided plurality of I/O requests. The processor inputs/outputs the divided data of the file held in the plurality of storage devices by using the assigned the plurality of I/O threads.

In another aspect of this invention, a processor for performing I/O processing and a disk device for storing data to be inputted/outputted are determined in the case where a host computer has a NUMA configuration. Further, a storage area of a memory for storing data to be inputted/outputted is determined.

In accordance with an embodiment of the present invention, one host computer to which a plurality of LUs (disk units) were connected can improve an I/O performance according to the number of disk units in the file system which divides and stores one file in a plurality of LUs.

Moreover, according to another embodiment of the present invention, when the one host computer has a NUMA configuration, according to the number of disk units, an I/O performance can be improved by selecting the processor which performs I/O processing, and the disk unit which stores a data for I/O.

Moreover, according to another embodiment of the present invention, when the one above-mentioned host computer is a NUMA configuration, according to the number of disk units, an I/O performance can be improved by selecting the processor which performs I/O processing, the disk unit which stores a data for I/O, and the memory area which stores a data for I/O.

### BRIEF DESCRIPTION OF THE DRAWINGS

The present invention can be appreciated by the description which follows in conjunction with the following figures, wherein:

FIG. 1 is a block diagram showing a configuration of a computer system in accordance with a first embodiment of this invention;

FIG. 2 is an explanatory diagram showing processor configuration information in accordance with the first embodiment of this invention;

FIG. 3 is an explanatory diagram for showing logical file configuration information in accordance with the first embodiment of this invention;

FIG. 4 is a diagram for showing I/O thread specification information in accordance with the first embodiment of this invention;

FIG. 5 is a flow chart showing processing performed by an I/O thread generation and I/O processing execution module in accordance with the first embodiment of this invention;

FIG. 6 is a flow chart showing a processing for determining a number of an I/O threads in accordance with the first embodiment of this invention;

FIG. 7 is a flow chart showing an I/O thread operation processor determination processing in accordance with the first embodiment of this invention;

FIG. 8 is a flow chart showing an I/O thread operation processor determination processing (a leveling processing) in accordance with the first embodiment of this invention;

FIG. 9 is a flow chart showing an I/O starting processing in accordance with the first embodiment of this invention;

FIG. 10 is a flow chart showing a file I/O completion processing in accordance with the first embodiment of this invention;

FIG. 11 is a flow chart showing a processing executed by a file system program in accordance with the first embodiment of this invention;

FIG. 12 is a flow chart showing a logical file I/O processing executed by the file system program in accordance with the first embodiment of this invention;

FIG. 13 is a block diagram showing a configuration of a computer system in accordance with a second embodiment of this invention;

FIG. 14 is a diagram showing processor configuration information in accordance with the second embodiment of this invention;

FIG. 15 is a diagram showing connected device information in accordance with the second embodiment of this invention;

FIG. 16 is a diagram showing file system configuration information in accordance with the second embodiment of this invention;

FIG. 17 is a flow chart showing an I/O thread operation processor determination processing in accordance with the second embodiment of this invention;

FIG. 18 is a flow chart showing an I/O thread operation processor determination processing (NUMA processing) in accordance with the second embodiment of this invention;

FIG. 19 is a block diagram showing a configuration of a computer system in accordance with a third embodiment of this invention;

FIG. 20 is a flow chart showing a processing executed by a per CPU board memory allocation processing execution module in accordance with the third embodiment of this invention;

FIG. 21 is a diagram showing memory and sub-data correspondence information in accordance with the third embodiment of this invention;

FIG. 22 is a diagram showing a problem of the embodiments; and

FIG. 23 is a diagram showing a configuration of a computer system according to the present embodiments.

### DETAILED DESCRIPTION OF THE PREFERRED EMBODIMENT

### First Embodiment

Hereinafter, embodiments of the present invention will be described with reference to the drawings.

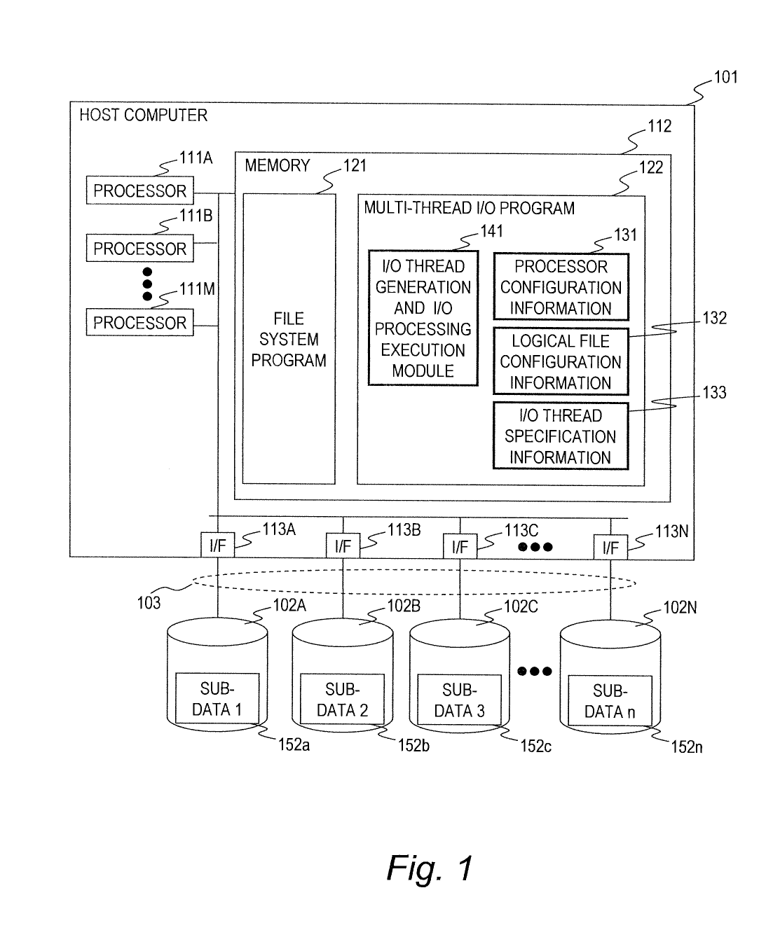

FIG. 1 is a block diagram showing a configuration of a computer system according to the first embodiment.

The computer system according to the first embodiment comprises a host computer 101, disk units (LU) 102A-102N, and storage networks 103. The host computer 101 is connected to the disk units 102A-102N via storage networks 103. Hereinafter, in the case where it is not necessary to distinguish the disk units 102A-102N, they are simply referred to as “disk unit(s) 102”.

The host computer 101 is a computer which executes various applications program by using LUs 102. The host computer 101 according to the first embodiment comprises processors 111A-111M which are mutually connected, a memory 112 and interfaces (I/Fs) 113A-113N. The processors 111A-111M, the memory 112 and the interfaces (I/F) 113A-113N are mutually connected. Hereinafter, in the case where it is not necessary to distinguish the processors 111A-111M, they/it are/is simply referred to as “processor(s) 111”. Moreover, in the case where it is not necessary to distinguish the interfaces 113A-113N, they/it are/is simply referred to as “interface(s) 113”.

The processors 111 are processors which execute programs stored in the memory 112. Processing which programs execute in the following descriptions is actually executed by the processors 111.

The memory 112 is a storage device which stores data such as data referred to by the processors 111 and a program executed by the processors 111. In the case where the memory 112 is a volatile semiconductor memory such as a DRAM, the programs and data, etc., may be stored in a hard disk drive (not illustrated), and all or a part of which may be loaded onto the memory 112 as needed. The memory 112 according to the first embodiment stores at least a file system program 121 and a multi-thread I/O program 122. A user-application program (not illustrated) which provides users with various functions may be further stored in the memory 112.

The multi-thread I/O program 122 is a program which performs I/O of data in multi-thread to a plurality of LUs connected to the host computer 101. The multi-thread I/O program 122 includes an I/O thread generation and I/O processing execution module 141, a processor configuration information 131, a logical file configuration information 132, and an I/O thread specification information 133. These will be described in detail later.

The file system program 121 may be a file system program which is provided as a part of operating system (OS) (not illustrated) or may be an I/O library which is used by the user application (not illustrated). The descriptions hereinafter can be applied also to a case where the file system program 121 is the I/O library.

The multi-thread I/O program 122 may be provided as a part of the file system program 121, although it is independently indicated as the file system program 121 in the drawing.

The I/F 113 is an interface which is connected to a storage network 103 and communicates with the LU 102 through the storage network 103.

The LUs 102 store data written by the host computer 101. The LUs are storage units which can store data which is provided to the host computer and which can be used by the host computer, and each of them comprises disk drives. Moreover, the LU may comprise a plurality of disk units in RAID configuration.

In the first embodiment, Fibre Channel (FC) protocol is used in the storage network 103. However, storage network 103 may use any kind of protocols other than FC protocol. In the case where a protocol other than FC protocol is used, each I/F 113 is replaced with an interface which suits with a network connected to the I/F 113.

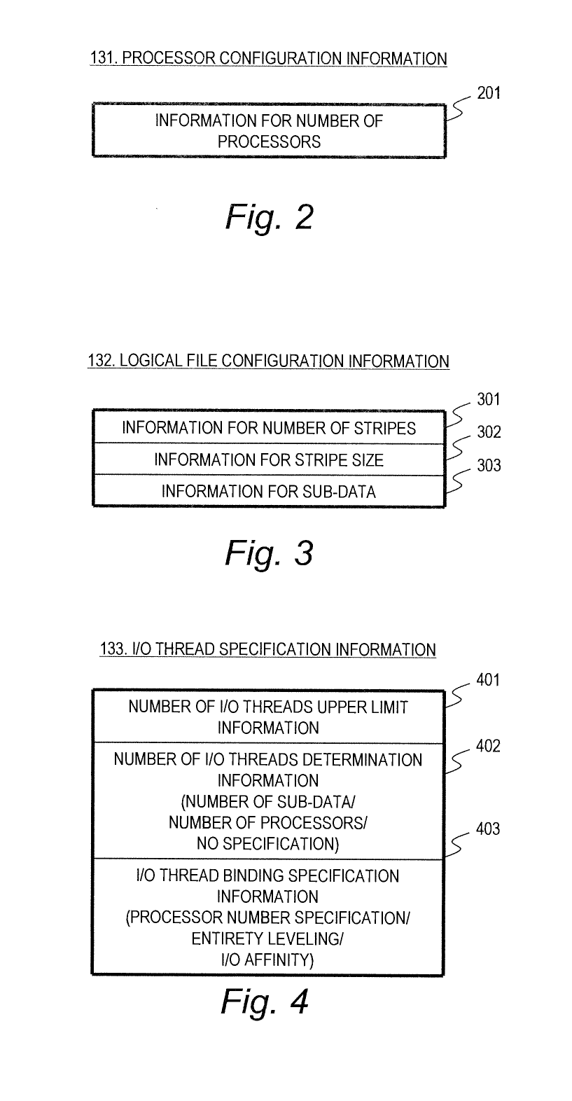

FIG. 2 is a diagram for showing the processor configuration information 131 according to the first embodiment.

The processor configuration information 131 includes information for number of processors 201 which indicates the number of processors of the host computer. The number of processors as used herein may be the number of physical processors or may be the number of logical processors. A “logical processor” is a processor having a simultaneous multi-threading (SMT) function, and is a virtual processor, and is a processor provided to applications. With the SMT, a processor is seen logically as a plurality of processors from software by having a plurality of virtual thread running units in one physical processor.

FIG. 3 is a diagram for showing the logical file configuration information 132 according to the first embodiment.

For example, the logical file configuration information 132 stores information which enables to treat sub-data 152 divided and stored in each LU 102 as a one logical file.

A logical file configuration information 132 includes information for numbers of stripes 301 indicating the number of sub-data 152, information for stripe size 302 indicating the striping unit (size) upon striping into sub-data, and information for sub-data 303 for identifying the location of sub-data.

Other than these, for example, the logical file configuration information 132 may include the name of the logical file, and information for managing a plurality of logical files with a tree structure.

FIG. 4 is a diagram for showing the I/O thread specification information 133 according to the first embodiment.

The I/O thread specification information 133 stores information used upon generating an I/O in connection with a file I/O processing or upon selecting an I/O thread among the I/O threads created in advance.

The I/O thread specification information 133 includes number of the I/O threads upper limit information 401 indicating an upper limit of the number of the I/O threads to be generated or selected, I/O determination information 402 indicating information for determining the number of the I/O threads to be used, and I/O thread binding specification information 403 indicating information for determining the processor to be bound to the generated or selected I/O thread.

Specifically, “number of sub-data” indicating that the number of the I/O threads is determined based on the number of sub-data of the logical file, and “number of processors” indicating the number of processors 111 the host computer 101 has are registered in the number of the I/O threads determination information 402.

A value does not necessarily need to be registered in the number of the I/O threads determination information 402. Moreover, the number of the I/O thread determination information 402 may not be included in the I/O thread specification information 133. In this case, the number of the I/O threads is determined according to an operation predetermined by the system.

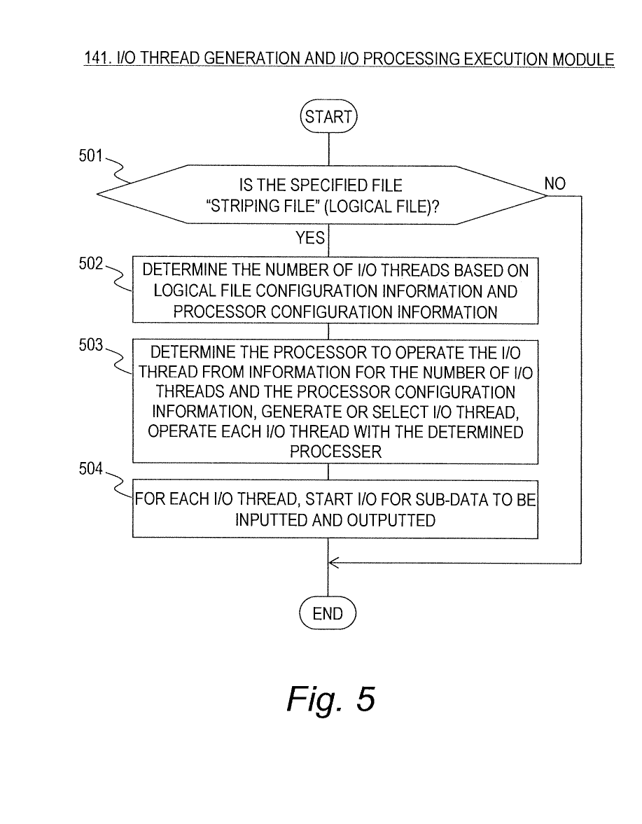

FIG. 5 is a flow chart showing processing performed by the I/O thread generation and I/O processing execution module 141 according to the first embodiment.

The I/O thread generation and I/O processing execution module 141 determines whether the specified file is a striping file (logical file) or not (Step 501). This determination is done by determining, for example, information on what kinds of files the directory including the file holds, the attribute information of the file, and whether the metadata of the file is referring to the logical file configuration information or not.

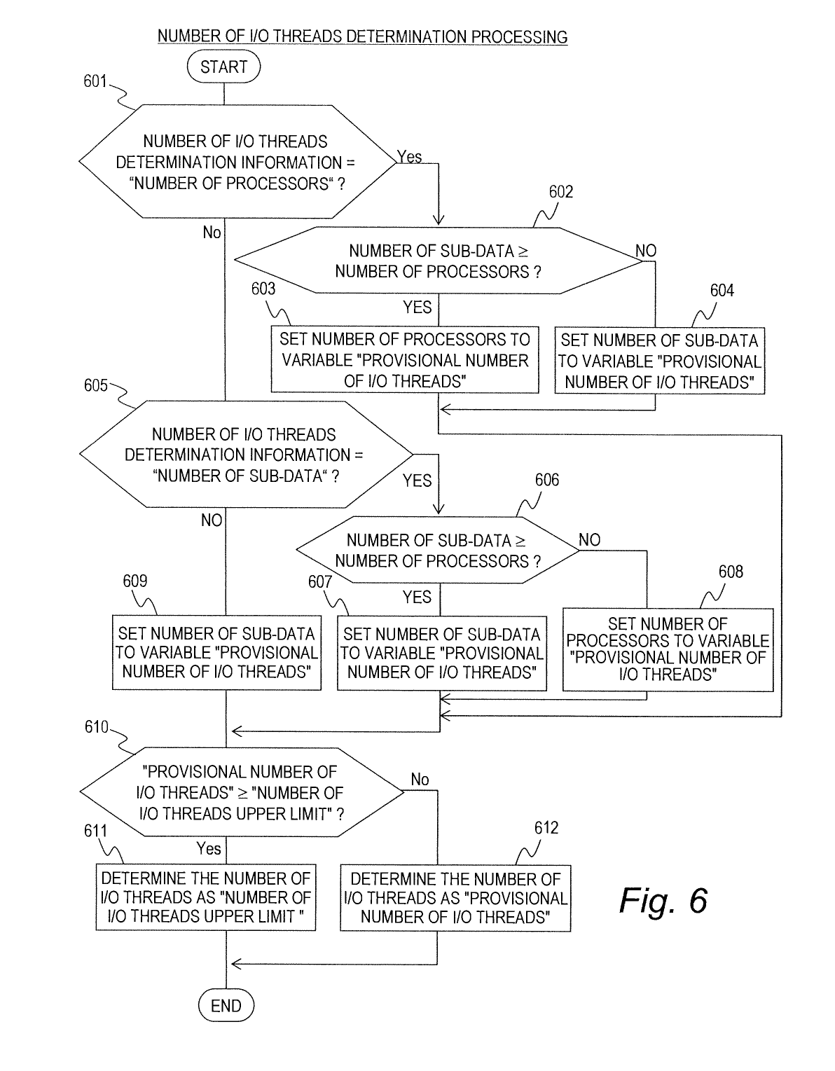

In Step 501, if it is determined that the specified file is a striping file, the I/O thread generation and the I/O processing execution module 141 determines the number of the I/O threads which performs the I/O of the specified file based on the processor configuration information 131 and the logical file configuration information 132 (Step 502). Processing for determining the number of the I/O threads which performs the I/O of the specified file will be described later with reference to FIG. 6.

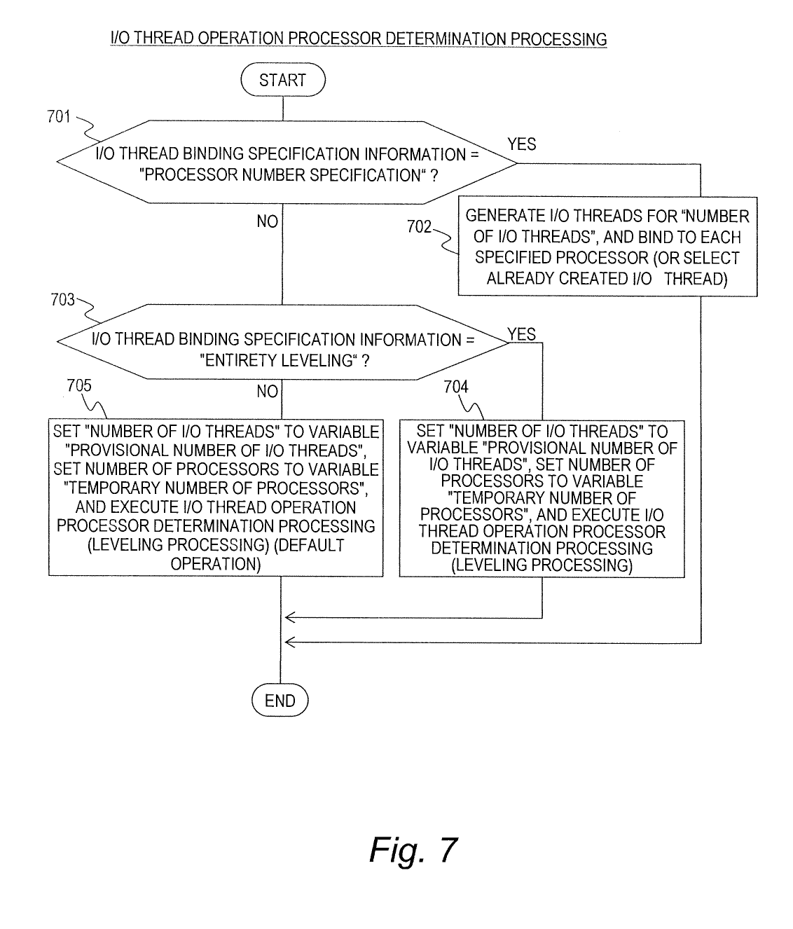

Next, the I/O thread generation and I/O processing execution module 141 determines the processor to operate the I/O thread from the number of the I/O threads determined at Step 502 and the processor configuration information 131, and generates or selects the I/O thread, and operates the generated or selected I/O threads with the determined processors (Step 503). Detailed processing at Step 503 will be described later with reference to FIG. 7.

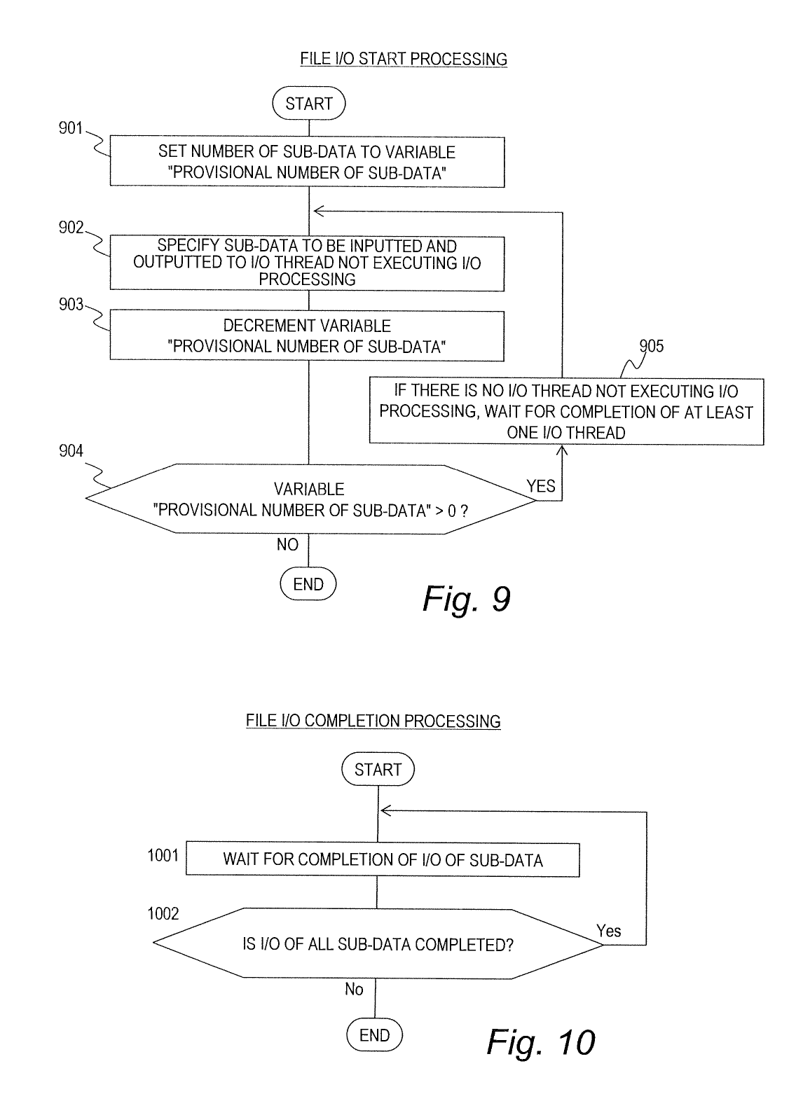

Then, I/O of sub-data to be outputted and inputted is started for each I/O thread that was generated or selected (Step 504). Processing for starting I/O at Step 504 will be described later with reference to FIG. 9. On the other hand, if it is determined that the specified file is not a striping file in Step 501, the process ends. Consequently, processing executed by the I/O thread generation and I/O processing execution module 141 is completed.

FIG. 6 is a flow chart showing the processing for determining the number of the I/O threads (Step 502) which is executed by the I/O thread generation and I/O processing execution module 141 according to the first embodiment.

The number of the I/O threads determination processing refers to the number of the I/O threads determination information 402 of the I/O thread specification information 133, and determines whether the value indicating the “number of processors” which shows the number of the processors 111 the host computer 101 has is registered or not (Step 601).

If it is determined that the value indicating the “number of processors” is registered in Step 601, the number of the I/O threads determination processing determines whether the number of sub-data of the file is more than the number of processors (Step 602).

If it is determined that the number of sub-data of the file is more than the number of processors in Step 602, the value of the number of processors is set to the variable “provisional number of the I/O threads” (Step 603).

Moreover, if it is determined that the number of sub-data of the file is not more than the number of processors in Step 602, the value of the number of sub-data is set to the variable “provisional number of the I/O threads” (Step 604).

On the other hand, if it is determined that the value indicating the “number of processors” is not registered in Step 601, the number of the I/O threads determination information 402 of the I/O thread specification information 133 is referred to determine whether the value representing the “number of sub-data” which indicates the number of sub-data of the specified file is registered or not (Step 605). If it is determined that the value representing “the number of sub-data” is registered in Step 605, the number of the I/O threads determination processing determines whether the number of sub-data of the file is more than the number of processors or not (Step 606).

If it is determined that the number of sub-data of the file is more than the number of processors in Step 606, the value of the number of sub-data is set to the variable “provisional number of the I/O threads” (Step 607).

Moreover, if it is determined that the number of sub-data of the file is not more than the number of processors in Step 606, the value of the number of processors is set to the variable “provisional number of the I/O threads” (Step 608).

On the other hand, if it is determined that the value indicating the “number of sub-data” is not registered in Step 605, the value of the number of sub-data is set to the variable “provisional number of the I/O threads” (Step 609).

Next, the number of the I/O threads determination processing refers to the number of the I/O threads upper limit information 401 of the I/O thread specification information 133, and determines whether the value of the variable “provisional number of the I/O threads” is greater than or equal to the value of the number of the I/O threads upper limit information 401 or not (Step 610).

If it is determined that the value of the variable “provisional number of the I/O threads” is greater than or equal to the value of the number of the I/O threads upper limit information 401 in Step 601, it determines to use the number of the I/O threads to the value of the number of the I/O threads upper limit information 401 (Step 611).

On the other hand, if it is determined that the value of the variable “provisional number of the I/O threads” is not greater than or equal to the value of the number of the I/O threads upper limit information 401 in Step 610, it determines to use the value of the variable “provisional number of the I/O threads” as the number of the I/O threads (Step 612).

Consequently, the number of the I/O threads determination processing is completed.

FIG. 7 is a flow chart showing the I/O thread operation processor determination processing (Step 503) which is executed by the I/O thread generation and I/O processing execution module 141 according to the first embodiment.

The I/O thread operation processor determination processing refers to the I/O thread binding specification information 403 of the I/O thread specification information 133 and determines whether the value indicating the “processor number specification” is registered or not (Step 701).

If it is determined that the value indicating the “processor number specification” is registered in Step 701, the I/O thread operation processor determination processing generates or selects the I/O thread for the “number of the I/O threads” that was determined in the number of the I/O threads determination processing shown in FIG. 6, and binds the I/O thread to each of the specified processors (Step 702)

The “binding” herein means to associate the I/O thread and the processor which operates the I/O thread, and to operate the I/O thread on the associated processor.

At this time, although not illustrated, the processor number for each processor is specified by a list including system parameters or environment variables. Specifically, it is specified like “0, 1, 2, 3, 4, 5, . . . ” when assigning in order of processor numbers, and it is specified like “0, 4, 8, . . . , 1, 5, 9, . . . ” when assigning in an order skipping three numbers. If the processor number can be specified, methods other than system parameters or environment variables can be used as the specification method.

On the other hand, if it is determined that the value indicating the “processor number specification” is not registered in Step 701, it refers to the I/O thread binding specification information 403 of the I/O thread specification information 133 and determines whether the value indicating “entirety leveling” is registered or not (Step 703).

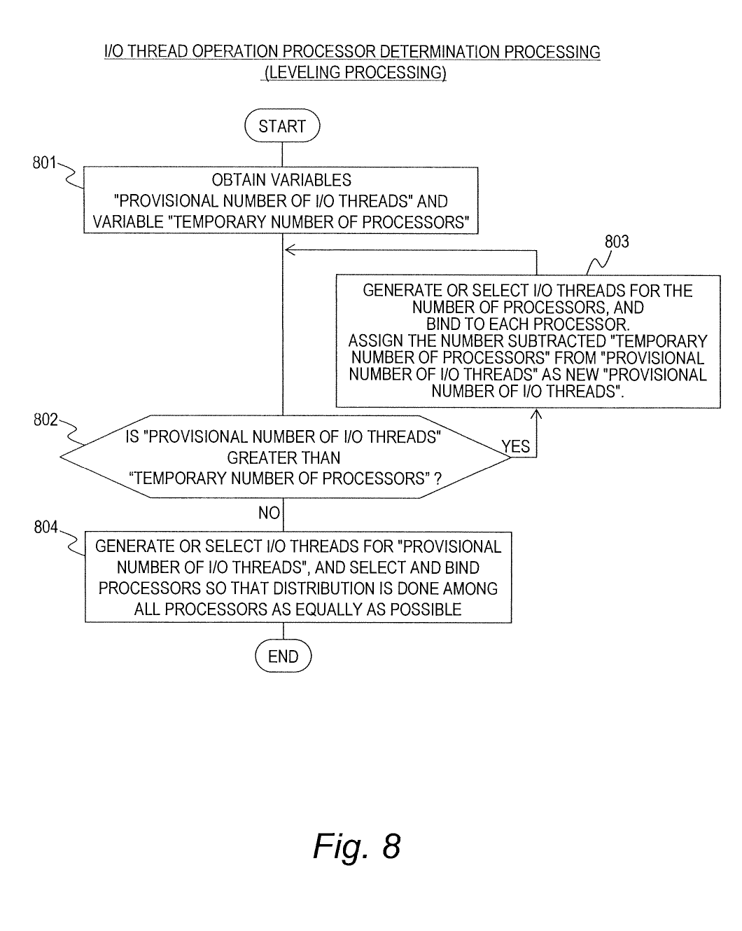

If it is determined that the value indicating “entirety leveling” is registered in Step 703, the I/O thread operation processor determination processing (leveling processing) which will be later described with reference to FIG. 8 is executed (Step 704). This leveling processing is performed after setting the “number of the I/O thread” to the variable “provisional number of the I/O threads” and setting the system-wide number of processors to the variable “temporary number of processors”.

On the other hand, if it is determined that the value indicating “entirety leveling” is not registered in Step 703, the default operation shown at Step 705 is executed. In this example, this default operation executes the same processing as the case where the value indicating “entirety leveling” is registered. As a result, the same processing as Step 704 is executed in Step 705. However, if other processing is used as the default operation, the processing at Step 705 may be replaced with the processing.

Consequently, the I/O thread operation processor determination processing is completed.

FIG. 8 is a flow chart showing the leveling processing (Step 704) which is executed in the I/O thread operation processor determination processing shown in FIG. 7.

First, the variables “temporary number of I/O threads” and the variable “temporary number of processors” which were specified at Step 704 in FIG. 7 are obtained (Step 801).

Next, it determines whether the value of the variable “provisional number of I/O threads” is larger than the variable “temporary number of processors” or not (Step 802).

If it is determined that the value of the variable “provisional number of I/O threads” is larger than the variable “temporary number of processors” in Step 802, the same number of the I/O threads as the “temporary number of processors” are generated or selected to be bound to each processor. Moreover, the number obtained by subtracting “temporary number of processors” from the “temporary number of I/O threads” is set to the new “temporary number of I/O threads” (Step 803).

After executing Step 803, Step 802 is executed again.

On the other hand, if it is determined that the value of the variable “provisional number of I/O threads” is smaller than or equal to the variable “temporary number of processors” in Step 802, the I/O threads for “provisional number of I/O threads” are generated or selected, and the processors are selected and bound so that the processors are distributed equally as possible (Step 804)

With above processing, the I/O thread operation processor determination processing (leveling processing) is completed.

FIG. 9 is a flow chart showing the I/O starting processing (Step 504) which is executed by the I/O thread generation and I/O processing execution module 141 according to the first embodiment.

First, the number of sub-data of the file is set to the variable “provisional number of sub-data” (Step 901).

Next, the sub-data for I/O is specified to the I/O thread which is not performing I/O processing and the I/O is started (Step 902), and the variable “provisional number of sub-data” is decremented (Step 903).

Next, it determines whether the variable “provisional number of sub-data” is larger than 0 or not (Step 904).

If it is determined that the variable “provisional number of sub-data” is larger than 0 at Step 904, there is sub-data which has not performed I/O yet. For this reason, if there is no I/O thread which is not performing I/O processing, it waits to complete the I/O of at least one I/O thread (Step 905), and execute Step 902 again.

If it is determined that the variable “provisional number of sub-data” is less than or equal to 0 in Step 904, it means that there is no sub-data which has not performed I/O yet, and therefore, the I/O starting processing ends.

FIG. 10 is a flow chart showing the file I/O completion processing for completing the I/O started in the I/O starting processing.

First, it waits for the completion of I/O of the sub-file one by one (Step 1001). Next, it determines whether I/O of all sub-data is completed or not (Step 1002). If it is determined that I/O of all sub-data is not completed yet at Step 1002, processing of Step 1001 is executed again.

On the other hand, if it is determined that I/O of all sub-data is completed at Step 1002, the file I/O completion processing ends.

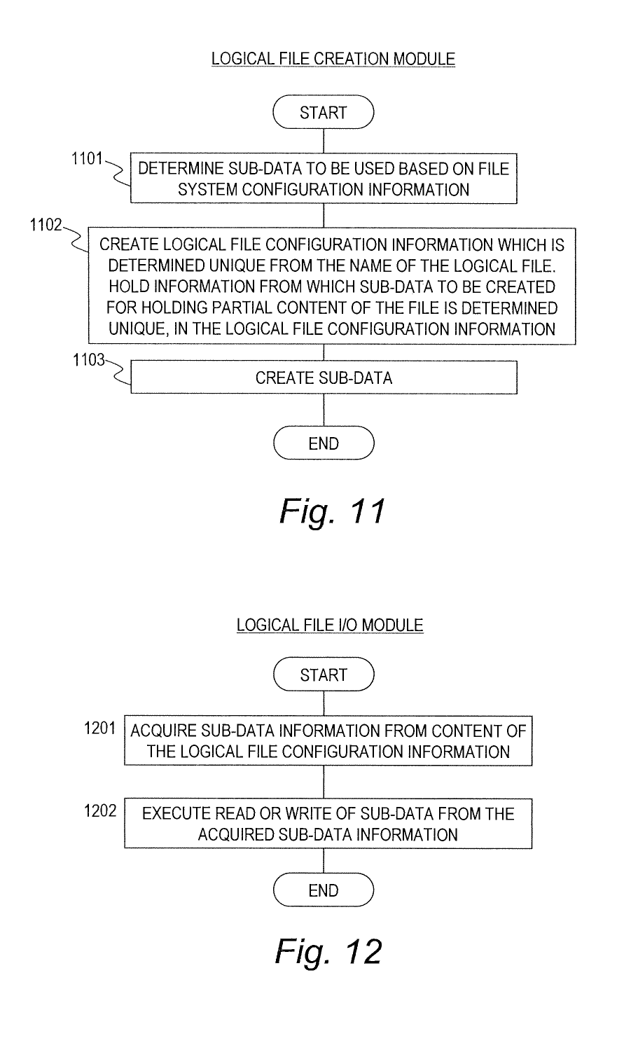

Processing shown in FIG. 11 is executed by the logical file creation module (not illustrated) in the file system program 121.

First, the logical file creation module determines sub-data which should be used based on file system configuration definition information (not illustrated) (Step 1101). Next, the logical file creation module creates logical file configuration information (not illustrated) on LUs connected to the host computer 101 (Step 1102). The logical file configuration information is determined unique based on the name of the logical file. This logical file configuration information includes information for determining unique sub-file(s) (not illustrated) created in each LU which should be used in order to hold partial contents of the logical file. The logical file configuration information 132 is made available by reading the logical file configuration information in the LU, and allocating it in the memory 122.

Next, the logical file creation module creates sub-data for holding partial content of the logical file in the LU to be used (Step 1103).

FIG. 12 is a flow chart showing the logical file I/O processing which is executed by the file system program 121 according to the first embodiment. Processing shown in FIG. 12 is executed by the logical file I/O module (not illustrated) in the file system program 121.

First, the logical file I/O module acquires information on sub-data which is determined according to the content of the file system configuration definition information (Step 1201).

Next, the logical file I/O module executes the reading or writing of the sub-data based on the acquired information on the sub-data (Step 1202).

Thus, according to the first embodiment, I/O performance can be improved according to the number of disk units by using a file system which divides one file into a plurality of LUs and stores them in a host computer which is connected to a plurality of LUs (disk units).

### Second Embodiment

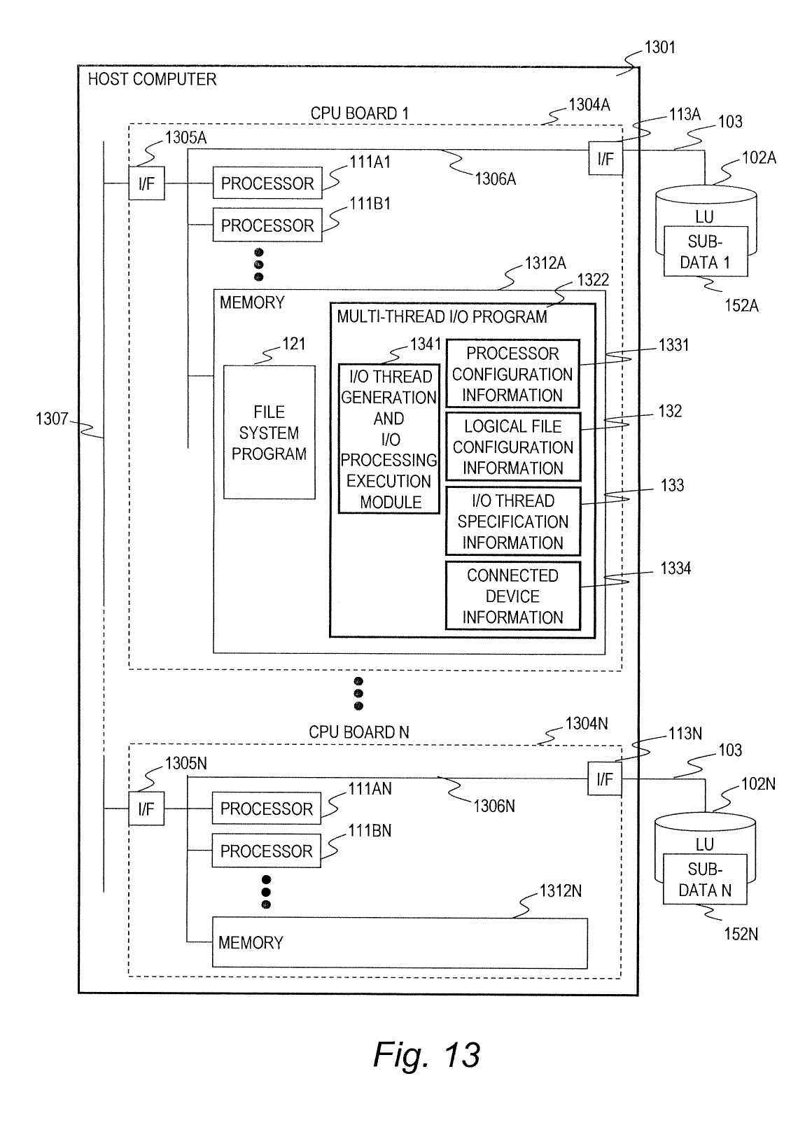

Hereinafter, second embodiment of the present invention will be described with reference to the drawings. FIG. 13 is a block diagram showing a configuration of the computer system according to the second embodiment.

The main difference between the second embodiment and the first embodiment is that the host computer has an NUMA (Non-Uniform Memory Access) configuration in the second embodiment. Components assigned same numerals as the first embodiment are the same as those in the first embodiment, and therefore, the descriptions are omitted for those components. NUMA is an architecture in which the cost for accessing the main memory and the I/O devices which are shared between a plurality of processors is not uniform depending on the performance of the memory area and the performance of the processors (see Reference 4). If the configuration of the first embodiment is applied to the host computer having the NUMA configuration, there are cases where the I/O throughput performance cannot be improved due to routing low throughput paths in the host computer.

In second embodiment, I/O throughput performance is improved in a host computer of an NUMA configuration by determining the processor to bind the I/O thread based on the location of I/F connected to LU which stores sub-data.

The computer system according to the second embodiment comprises a host computer 1301, disk units 102, and storage networks 103. The host computer 1301 is connected to the disk units 102 through storage networks 103.

In the host computer 1301, it comprises a plurality of CPU boards 1304A-1304N, and an inter-CPU board network 1307 which connects between the CPU boards 1304A-1304N.

The CPU board 1304A comprises processors 111A1, 111B1 which are connected with each other, a memory 1312A, an interface (I/F) 113A, an intra-CPU board network 1306A, and an inter-CPU board network I/F 1305A. The inter-CPU board network I/F 1305A is an interface which communicates with other CPU boards through the inter-CPU board network 1307.

The memory 112 according to the second embodiment stores at least a file system program 121 and a multi-thread I/O program 1322. The multi-thread I/O program 1322 is a program which performs multi-thread I/O to a plurality of LUs connected to the host computer 101. The multi-thread I/O program 1322 includes an I/O thread generation and I/O processing execution module 1341, processor configuration information 1331, logical file configuration information 132, I/O thread specification information 133, and connected device information 1334. These will be described in detail later.

The file system program 121 may be a file system program provided as a part of the operating system (OS) (not illustrated), and may be an I/O library used by the user application (not illustrated). The following descriptions can be applied also to a case where the file system program 121 is an I/O library. The multi-thread I/O program 1322 may be provided as a part of the file system program 121, although it is indicated separately to the file system program 121 in the figure. The I/F 113 is an interface which is connected to the storage networks 103 and communicates with the LU 102 through a storage network 103.

The LU 102 stores data written by the host computer 101.

The performance of the inter-CPU board network 1307 differs from the performance of the intra-CPU board network 1306. Generally, as to the performance of the inter-CPU board network 1307, the throughput performance is lower than that of the intra-CPU board network 1306.

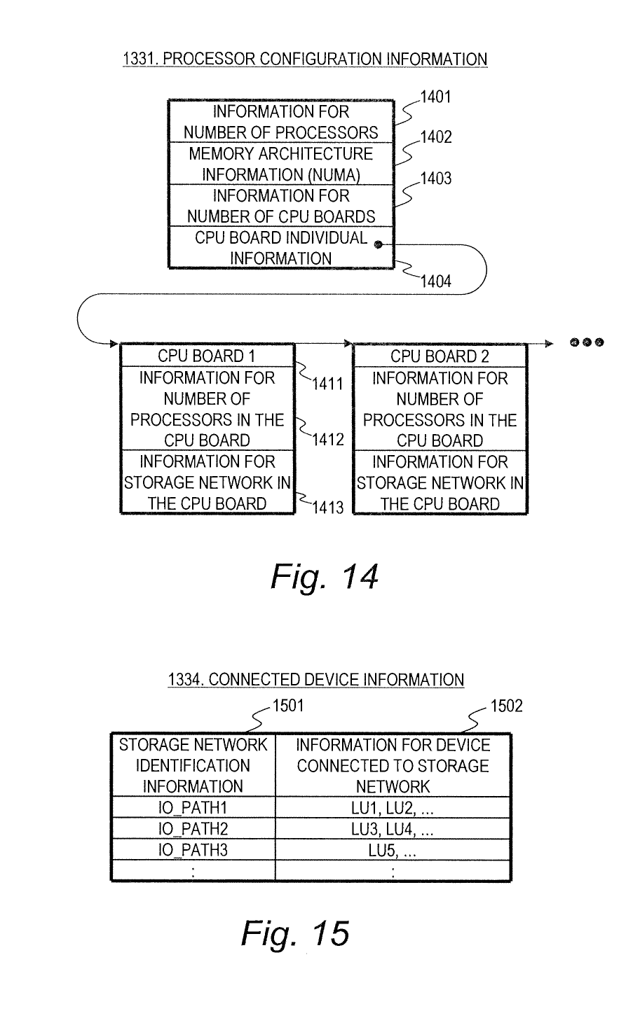

FIG. 14 is a diagram showing the processor configuration information 1331 according to the second embodiment. The processor configuration information 1331 contains information for number of processors 1401 which shows the number of processors in the host computer, memory architecture information 1402 which shows the memory architecture of the host computer, information for the number of CPU boards 1403, and CPU board individual information 1404.

The CPU board individual information 1404 offers pointers to the structure which show the individual information of each CPU board. The individual information of a CPU board comprises identification information of the CPU board 1411, information for number of processors in the CPU board 1412, and I/O path information in the CPU board 1413.

FIG. 15 is a diagram showing the connected device information 1334 according to the second embodiment. The connected device information 1334 manages network identification information 1501 which is determined from the connected location of the CPU board, the I/F 113 included in the CPU board, or the storage network 103, and identification information 1502 of the LU 102 connected to the network.

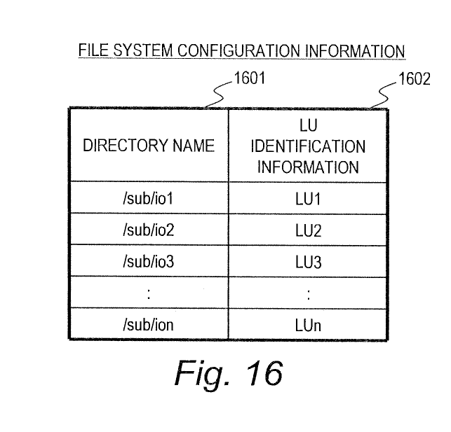

FIG. 16 is a diagram showing the file system configuration information which associates the identification information of the LU 102, and the LU which stores sub-data, according to the second embodiment, which is not illustrated in FIG. 14. The file system configuration information stores the directory name 1601 of the mount point which stores sub-data, and the identification information 1602 of the corresponding LU.

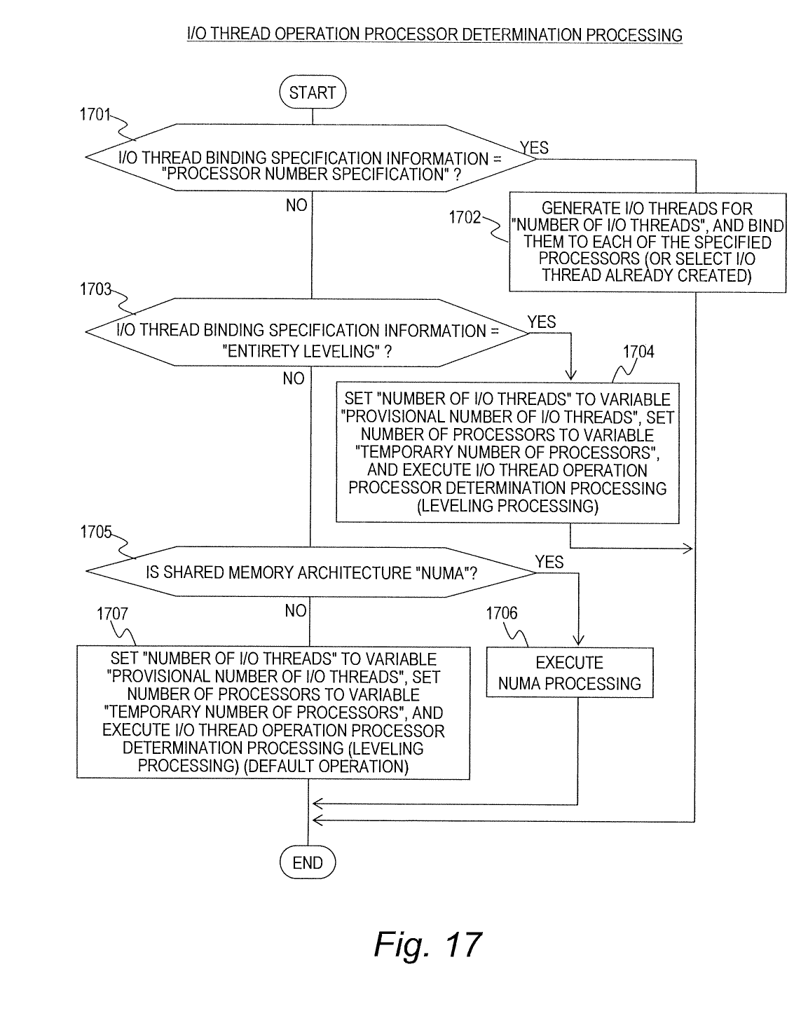

FIG. 17 is a flow chart showing the I/O thread operation processor determination processing (Step 503) which is executed by the I/O thread generation and I/O processing execution module 1341 according to the second embodiment.

The I/O thread operation processor determination processing refers to the I/O thread binding specification information 403 of the I/O thread specification information 133, and determines whether the value indicating the “processor number specification” is registered or not (Step 1701). If it is determined that the value indicating the “processor number specification” is registered in Step 1701, the I/O thread operation processor determination processing generates or selects the I/O threads for the “number of I/O threads” determined in the number of the I/O threads determination processing shown in FIG. 6 (Step 1702) The binding herein associates an I/O thread and the processor which operates the I/O thread, and operates the I/O thread on the associated processor.

Although not illustrated, at this time, the processor number of each processor is specified by system parameters and environment variables with lists. Specifically, it is specified like “0, 1, 2, 3, 4, 5, . . . ” when assigning in order of processor numbers, and it is specified like “0, 4, 8, . . . , 1, 5, 9, . . . ” when assigning in an order skipping three numbers. If the processor number can be specified, methods other than system parameters or environment variables can be used as the specification method.

On the other hand, if it is determined that the value indicating the “processor number specification” is not registered in Step 1701, the I/O thread binding specification information 403 of the I/O thread specification information 133 is referred to determine whether the value indicating “entirety leveling” is registered or not (Step 1703).

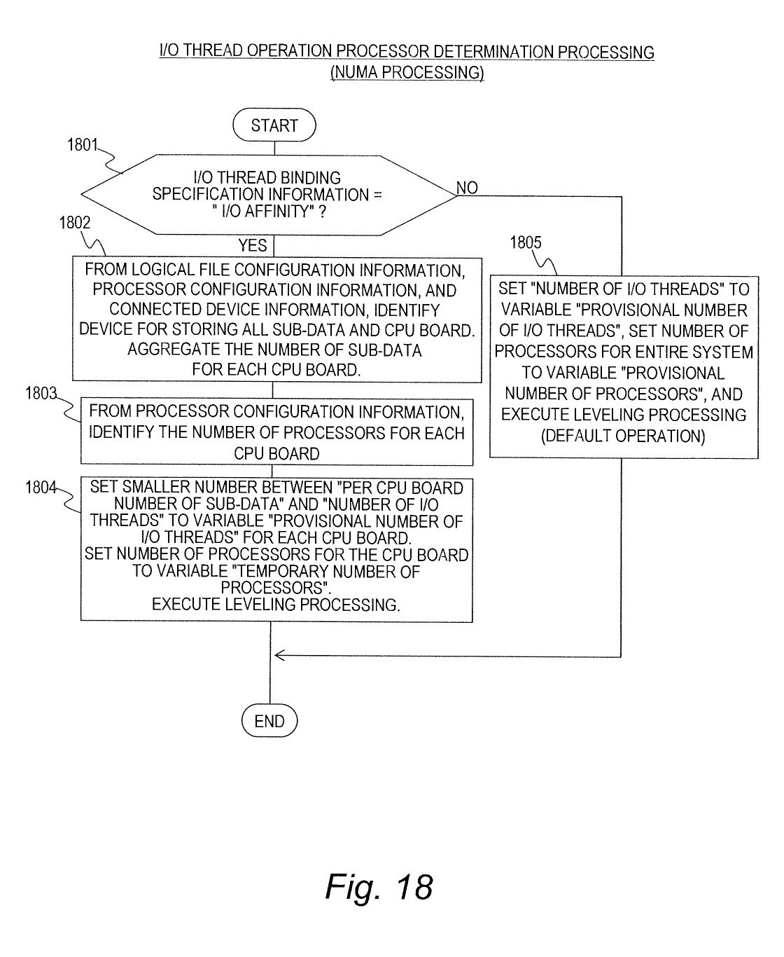

If it is determined that the value indicating “entirety leveling” is registered in Step 1703, I/O thread operation processor determination processing (leveling processing) which will be described later with reference to FIG. 18 is executed (Step 1704). This leveling processing is executed after setting the “number of I/O threads” to the variable “provisional number of I/O threads” and setting the system-wide number of processors to the variable “provisional number of processors”.

On the other hand, if it is determined that the value indicating “entirety leveling” is registered in Step 1703, the memory architecture information 1402 of the processor configuration information 1331 is referred to determine whether the value indicating “NUMA” is registered or not (Step 1705).

If it is determined that the value indicating “NUMA” is registered in Step 1705, I/O thread operation processor determination processing (NUMA processing) which will be described later with reference to FIG. 18 is executed (Step 1706).

On the other hand, if it is determined that the value indicating “entirety leveling” is not registered in Step 1703, the default operation shown at Step 1707 is executed. In this example, this default operation executes the same processing as the case where the value indicating “entirety leveling” is registered. As a result, processing same as Step 1704 is executed in Step 1707. However, in the case where another processing is used as the default operation, that processing may replace Step 1707. Consequently, the I/O thread operation processor determination processing is completed.

FIG. 18 is a flow chart showing NUMA processing (Step 1706) which is executed in the I/O thread operation processor determination processing shown in FIG. 17.

The I/O thread operation processor determination processing (NUMA processing) refers to the I/O thread binding specification information 403 of the I/O thread specification information 133, and determines whether the value indicating “I/O affinity” is registered or not (Step 1801). If it is determined that the value indicating “I/O affinity” is registered in Step 1801, the number of sub-data stored in the LU connected to the CPU board is aggregated for each CPU board in the host computer from the logical file configuration information 132, the processor configuration information 1331, and the connected device information 1334 (Step 1802).

Next, the number of processors for each CPU board is identified from the processor configuration information 1331 (Step 1803). Furthermore, the I/O thread operation processor determination processing (leveling processing) is executed for each CPU board (Step 1804). It is noted that this leveling processing is executed after setting the smaller number of the “number of sub-data for each CPU board” and the “number of I/O threads” to the variable “provisional number of I/O threads” and setting the number of processors in the CPU board to the variable “temporary number of processors”.

On the other hand, if it is determined that the value indicating “I/O affinity” is not registered in Step 1801, the I/O thread operation processor determination processing (leveling processing) is executed (Step 1805). Upon executing this leveling processing, the “number of I/O thread” is set to the variable “provisional number of I/O threads”, and the system-wide number of processors is set to the variable “temporary number of processors”.

Consequently, the I/O thread operation processor determination processing (NUMA processing) is completed.

According to the second embodiment, in the host computer having a NUMA configuration, I/O performance can be improved in accordance with the number of disk units using a file system which divides and stores one file into a plurality of LUs by selecting the processor which performs I/O processing, and the disk unit which stores data for I/O.

### Third Embodiment

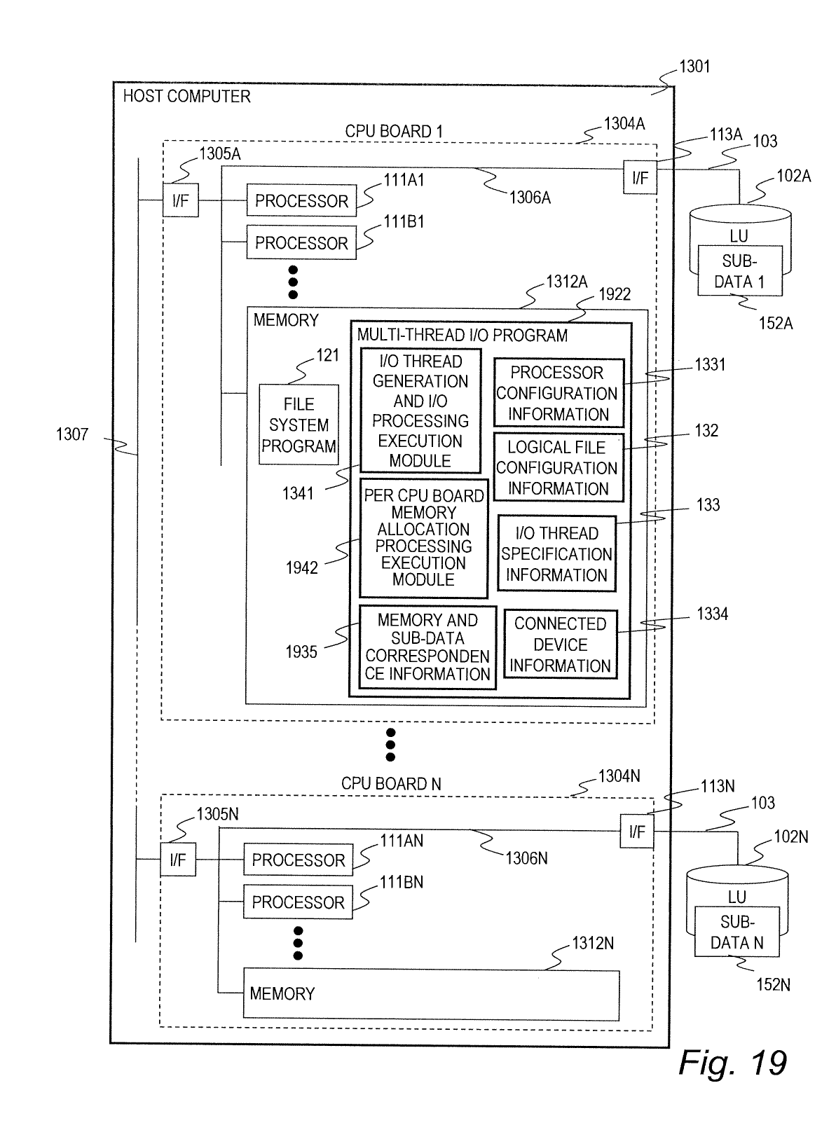

Hereinafter, third embodiment of the present invention will be described with reference to the drawings. FIG. 19 is a block diagram showing a configuration of the computer system according to the third embodiment. The configuration of the third embodiment is almost the same as the configuration of the second embodiment. The configuration assigned the same numerals as the first and second embodiments are the same as those in the first and second embodiments, and therefore, their descriptions are omitted. According to the second embodiment, it is possible to boost the I/O throughput performance in a host computer having a NUMA configuration. However, it cannot improve the I/O throughput performance in the case where the total I/O throughput performance of the plurality of LUs is relatively high compared to the throughput performance of NUMA having the low throughput routing.

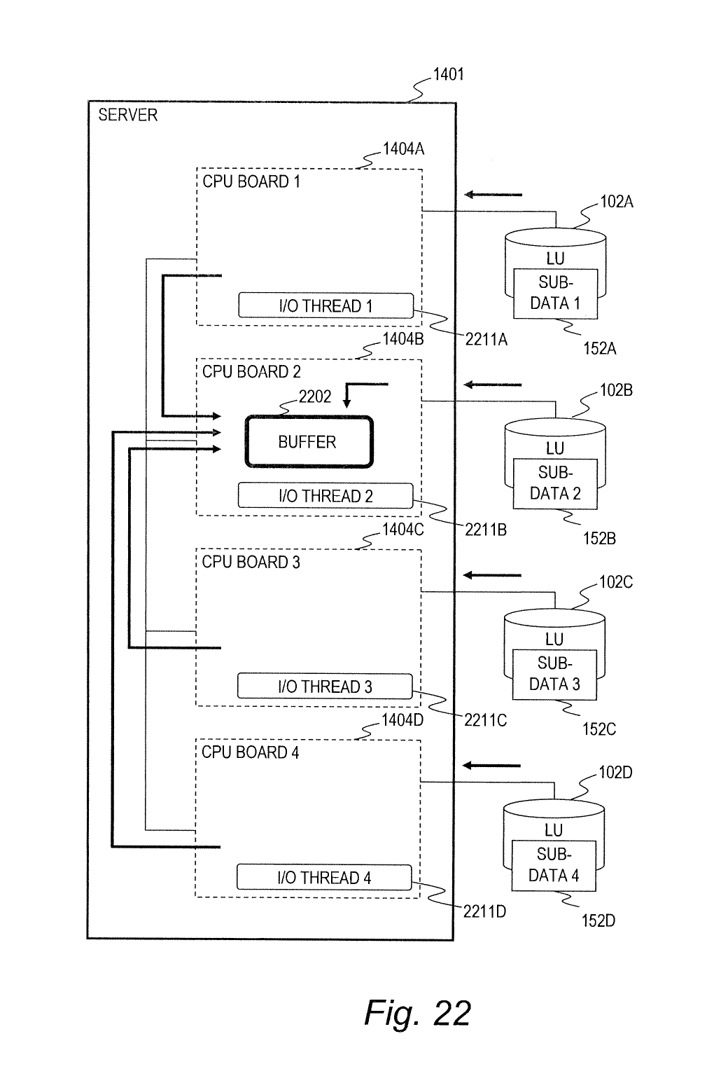

This problem will be described briefly with reference to FIG. 22. FIG. 22 illustrates an configuration of the computer system according to the third embodiment, sub-data stored in LUs, and that I/O threads are bound to arbitrary processors in each CPU board one by one.

Generally a user program (not illustrated) is executed by certain one of the processors in either one of the CPU boards. A memory affinity control of OS is carried out in response to the memory allocation request from the user program, and a storage region is secured within the CPU board which includes the processor executing the user program. This example shows that a buffer has been secured in the memory in the CPU board 2. As shown in FIG. 22, a plurality of pieces of sub-data for I/O between LUs connected to each CPU board undergo I/O through the low throughput route between the CPU boards, except for sub-data 2 stored in the LU connected to the CPU board 2.

In this case, the total I/O throughput performance of a plurality of LUs cannot be used in the case where the total I/O throughput performance of a plurality of LUs is high compared to the throughput performance of the low throughput route of NUMA. That is, even if the throughput performance in the CPU board connected to the LU is high, the memory in the CPU board 2 is accessed via the low throughput route between the CPU boards, and therefore, the throughput performance in response to the I/O request for files decreases. In the third embodiment, the I/O of the data is done in consideration of the location in the memory where the sub-data is stored, and thereby, it is possible to improve the I/O throughput performance in a host computer having a NUMA configuration in the case where the total I/O throughput performance of a plurality of LUs is high compared to the throughput performance of the low throughput route of NUMA. For this reason, the third embodiment is different from the second embodiment in that it includes a per CPU board memory allocation processing execution module 1942, and a memory and sub-data correspondence table 1935 in the multi-thread I/O program 1922. These will be described in detail later.

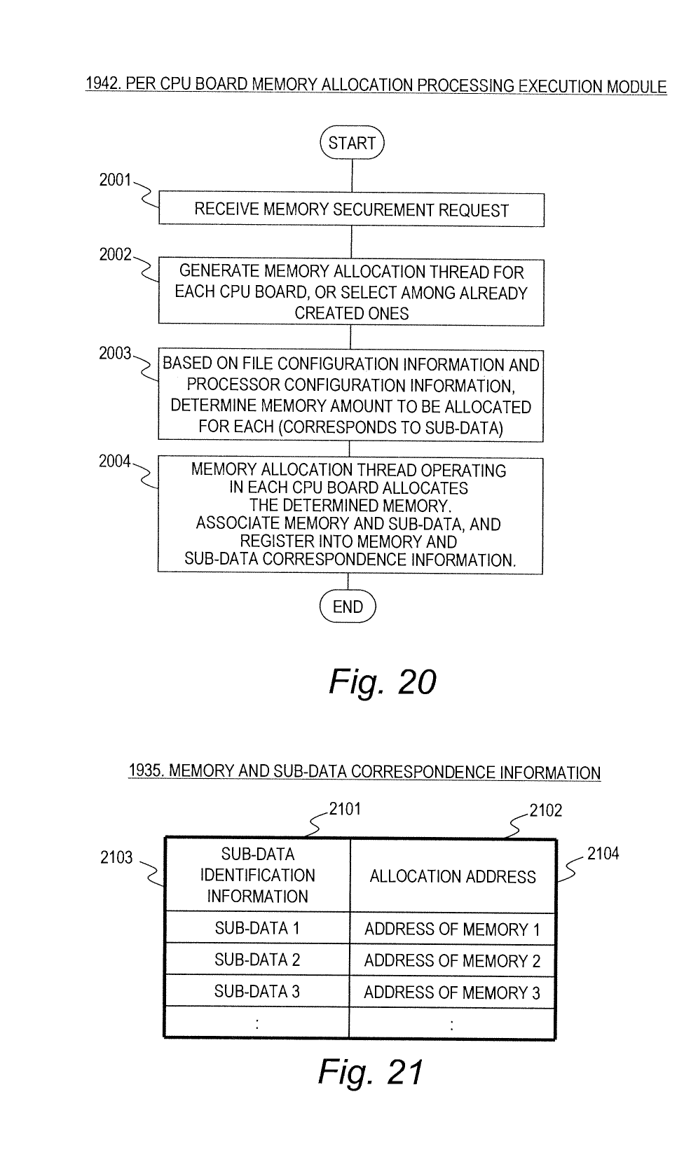

FIG. 20 is a flow chart showing a per CPU board memory allocation processing execution module which is executed by the memory allocation processing execution module 1942 according to the third embodiment. The per CPU board memory allocation processing execution module receives memory securement requests for inputting and outputting data before the stage of the file I/O (Step 2001).

In response to this request, the processor configuration information 1331 is referred to generate the memory allocation thread for each CPU board or select among the already created ones (Step 2002).

Next, based on the file configuration information and the processor configuration information, the amount of memory for assigning to each CPU board is determined (Step 2003). The amount of memory for assigning to each CPU board is determined so that the memory for storing the sub-data is secured in the CPU board to which the LU storing the sub-data is connected. This securement of the memory by specifying the CPU board can be done with usual memory assignment which makes use of the memory affinity function of the OS which operates in the host computer of the usual NUMA configuration.

Finally, the memory allocation thread which operates in each CPU board allocates the memory of the amount determined at Step 2003. At this time, the allocated memory and the sub-data are associated, and registered to the memory and sub-data correspondence information 1935 to end the process.

FIG. 21 is a diagram showing the memory and sub-data correspondence information according to the third embodiment. The memory and sub-data correspondence information associates and stores information 2101 for identifying sub-data, such as the name of sub-data, and the address of memory 2102 allocated to the sub-data. In the processing for starting the I/O of the memory corresponding to the sub-data assigned as described in the above, the I/O data is directly transmitted to the user buffer without routing the OS buffer, and thereby, the I/O of sub-data does not route the low throughput route of NUMA.

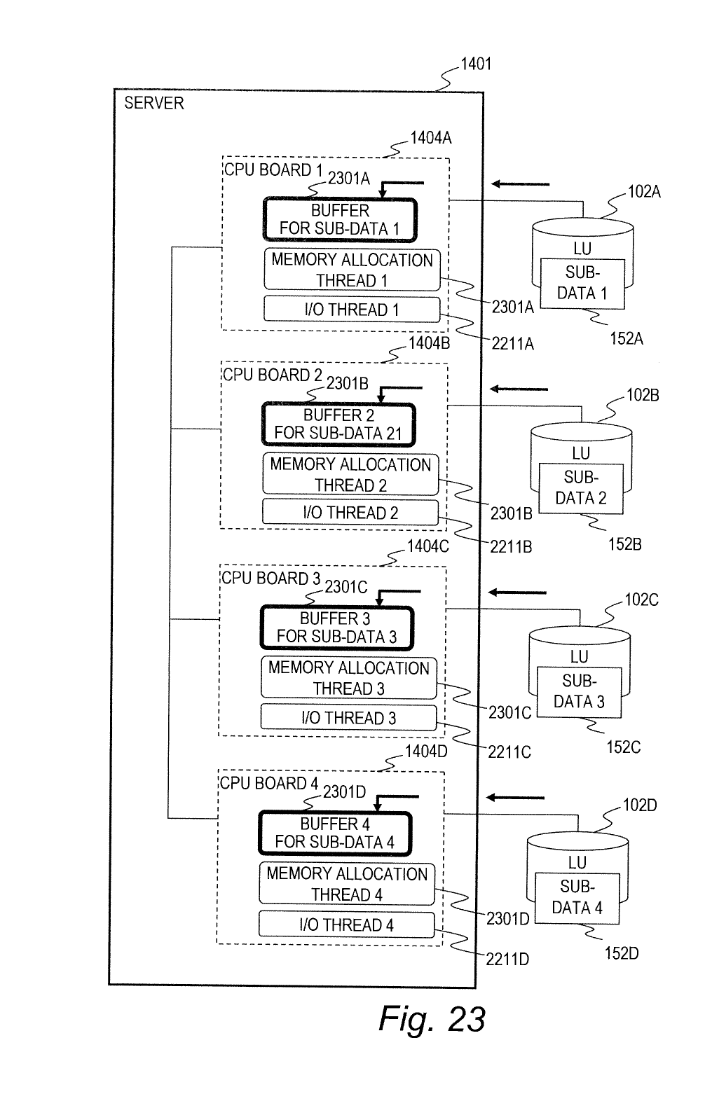

FIG. 23 illustrates an configuration of a computer system according to the third embodiment, sub-data stored in LUs, and that the memory allocation threads and the I/O threads are bound to arbitrary processors in each CPU board one by one. As shown in FIG. 23, a plurality of pieces of sub-data that undergo I/O between LUs connected to the CPU boards do not route the low throughput route between the CPU boards since as to each piece of sub-data, only the transmission between the buffer in the CPU board to which the LU storing the sub-data is connected occurs. For this reason, it is possible to improve the total I/O throughput performance of a plurality of LUs even if it is higher than the throughput performance of the low throughput route of NUMA.

According to the third embodiment, in a host computer having a NUMA configuration, I/O performance can be improved in accordance with the number of disk units using a file system which stores one file by dividing into a plurality of LUs, by selecting the processor which performs I/O processing, the disk unit which stores data for I/O, and the allocation location of the memory area corresponding to the data for I/O.

While the present invention has been described in detail and pictorially in the accompanying drawings, the present invention is not limited to such detail but covers various obvious modifications and equivalent arrangements, which fall within the purview of the appended claims.

What is claimed is:

1. A computer system comprising a computer and a plurality of storage devices coupled to the computer via a network, wherein
the plurality of storage devices store divided data which is obtained by dividing data contained in a file which can be accesed by the computer;
the computer comprises an interface coupled to the network, a processor coupled to the interface, and a memory coupled to the processor;
the computer is configured to:
hold configuration information of the processor included in the computer and configuration information of the file which is stored by dividing the file;
divide an I/O request of the file into a plurality of I/O requests for the plurality of storage devices;
determine whether a predetermined condition is satisfied or not; and
assign a plurality of I/O threads of a number determined based on a result of the determination to the divided plurality of I/O requests; and
the processor inputs/outputs the divided data of the file held in the plurality of storage devices by using the assigned the plurality of I/O threads.

2. The computer system according to claim 1, wherein the computer is configured to determine whether the predetermined condition is satisfied or not by using a number of processors included in the computer.

3. The computer system according to claim 1, wherein the computer is configured to determine whether the predetermined condition is satisfied or not by using a number of the division of the data of the file.

4. The computer system according to claim 2, wherein the computer is configured to determine the processor to operate the plurality of I/O threads by a predetermined method.

5. The computer system according to claim 4, wherein the computer is configured to determine, in the predetermined method, the processor having a specified processor number as the processor to operate the I/O threads in a case where the processor number is specified.

6. The computer system according to claim 4, wherein the computer is configured to determine, in the predetermined method, that the plurality of I/O threads are distributed to the plurality of processors in a case where it is specified to distribute the I/O threads to the plurality of processors.

7. A computer system comprising a computer and a plurality of storage devices coupled to the computer via a network, wherein
the storage device stores divided data which is obtained by dividing data contained in a file which can be accessed by the computer; and
the computer comprises:
a plurality of processor units comprising an interface coupled to the network, a processor coupled to the interface, and a memory coupled to the processor;
an inter-processor unit network for coupling between the plurality of processor units; and
an inter-processor unit interface for coupling the inter-processor unit network and the processor unit; and
the computer is configured to:
hold configuration information of the processor, configuration information of the file to be stored by dividing the file, and storage device information representing the storage device coupled to each processor unit;
determine whether a predetermined condition is satisfied or not in a case where an I/O request for the file is divided into a plurality of I/O requests for the plurality of storage devices;
assign a plurality of I/O threads of a predetermined number and the plurality of processor units to the divided plurality of I/O requests in a case of which it is determined that the predetermined condition is satisfied; and
input/output the divided data of the file held in the plurality of storage devices by using the plurality of I/O threads.

8. The computer system according to claim 7, wherein the computer is configured to determine whether the predetermined condition is satisfied or not by using a number of processors included in the computer.

9. The computer system according to claim 7, wherein the computer is configured to determine whether the predetermined condition is satisfied or not by using number of the division of the data of the file.

10. The computer system according to claim 7, wherein the computer is configured to determine whether the predetermined condition is satisfied or not based on whether the computer has a memory configuration in which an access route from the processor included in the computer to the memory includes the inter-processor unit network.

11. The computer system according to claim 7, wherein the computer is configured to determine the processor to operate the plurality of I/O threads by a predetermined method.

12. The computer system according to claim 11, wherein the computer is configured to determine, in the predetermined method, the processor to operate the plurality of I/O threads based on the configuration of the plurality of processor units.

13. The computer system according to claim 7, wherein
the computer is configured to:
allocate storage areas of a number of the division of the data contained in the file in response to a request to allocate the memory for storing the data contained in the file;
allocate the storage areas to the plurality of processor units coupled to the storage devices for storing the divided data;
hold correspondence information between the divided data and the allocated storage area; and
use the storage area corresponding to the divided data in a case where the plurality of I/O threads inputs/outputs the data.

14. The computer system according to claim 13, wherein
the computer is configured to:
hold configuration information of the memory; and
determine that the predetermined condition is satisfied if an access route from the processor included in the computer to the memory includes an inter-processor unit network by referring to the memory configuration information.

15. A method of controlling a computer system having a computer and a plurality of storage devices coupled to the computer through a network,
the plurality of storage devices storing divided data which is obtained by dividing data contained in a file which can be accessed by the computer;
the computer having an interface coupled to the network, a processor coupled to the interface, and a memory coupled to the processor;
the computer holding configuration information of the processor included in the computer and configuration information of the file to be stored by dividing the file; and
the method comprising the steps of:
determining whether a predetermined condition is satisfied or not in a case where dividing an I/O request for the file is divided into a plurality of I/O requests for the plurality of storage devices;
assigning a plurality of I/O threads of a predetermined number to the processor based on the result of the determination,; and
performing input/output each of the divided data of the file held in the plurality of storage devices by each of the plurality of I/O threads.

16. A method of controlling a computer system comprising a computer and a plurality of storage devices coupled to the computer through a network,
the computer comprising an interface coupled to the network, a processor coupled to the interface, and a memory coupled to the processor;
the computer having: a plurality of processor units each including the processor, the memory and the interface; an inter-processor unit network which for coupling between the plurality of processor units; and an inter-processor unit interface for coupling the inter-processor unit network and the processor unit;
the computer holding configuration information of the processor, configuration information of the file to be stored by dividing the file, and storage device information representing the storage device coupled to each processor unit; and
the method comprising the steps of:
storing the data contained in a file by dividing into the plurality of storage devices;
determining whether a predetermined condition is satisfied or not in a case where an I/O request for the file into a plurality of I/O requests for the plurality of storage devices in response to the I/O request for the file;
creating or selecting a plurality of I/O threads of a predetermined number in a case where it is determined that the predetermined condition is satisfied; and
inputting/outputting the divided data of the file held in the plurality of storage devices by using the plurality of I/O threads.

17. The method according to claim 16, further comprising the steps of:
allocating storage areas of a number of the division of the data contained in the file in response to an allocation request of the memory for storing the data contained in the file;
allocating the storage areas to the plurality of processor units coupled to the storage devices for storing the divided data;
holding correspondence information between the divided data and the allocated memory area; and
using the storage area corresponding to the divided data in a case where the plurality of I/O threads input/output the data.
